(19) United States
(12) Patent Application Publication
(10) Pub. No.: US 2007/0111237 A1
(43) Pub. Date: May 17, 2007

(54) Process for identifying antigenized antibodies using ribosome cell free expression system

(76) Inventor: Maurizio Zanetti, La Jolla, CA (US)

Correspondence Address: MORGAN, LEWIS & BOCKIUS, LLP, ONE MARKET SPEAR STREET TOWER, SAN FRANCISCO, CA, 94105, US

(21) Appl. No.: 11/520,997

(22) Filed: Sep. 14, 2006

Related U.S. Application Data
(60) Provisional application No. 60/717,355, filed on Sep. 14, 2005.

(51) Int. Cl. C40B 30/06; C40B 40/08; C40B 40/10

(52) U.S. Cl. 435/6; 435/7.1

(57) ABSTRACT

A process comprising (1) contacting a single-chain variable region (ScVr) mRNA library with a cell free ribosome expression system to produce a library of complexes each comprising a ribosome, an ScVr mRNA and a nascent single chain antigenized antibody encoded by the ScVr mRNA (ARM complexes) wherein the ScFv mRNA library is randomized in at least one CDR region; (2) contacting the ARM complexes with an antigen-specific antibody or receptor under conditions that permit binding of the antigen-specific antibody or receptor with a randomized CDR loop of the antigenized antibody of one or more of the ARM complexes; and (3) separating ARM complexes bound to the antibody from ARM complexes that do not bind antigen specific antibody.

### TECHNICAL FIELD

The invention relates to methods for identifying antigenized antibodies and uses of such antibodies.

### BACKGROUND OF INVENTION

The immunogenicity of proteins is based on discrete sites, antigenic determinants or epitopes. In the case of an antibody (B-cell) response, epitopes are determined either by amino acid residues that are not contiguous in the protein primary structure but come in contact in the folding of the molecule (conformational determinants) or by a continuous sequence of amino acids (linear determinants). Understanding the antigenic and immunogenic sites of a protein (be this from a pathogen, a tumor, a toxin etc.) requires that these epitopes be mapped with the aid of molecular or atomic techniques.

The definition and characterization of epitopes in proteins of biological interest can be achieved by several methods including site-directed mutagenesis, x-ray crystallography and deuterium exchange mass spectrometry. All of these methods are labor-intensive and expensive. A practical approach used in the past has been to use synthetic peptides as surrogate replica of selected portions of a protein. Synthetic peptide epitopes are poor immunogens and fail in general to elicit antibodies that cross-react with the native protein (Zanetti, Nature 355, 466-477 (1992)). This is due to an unstable three-dimensional structure that fails to correctly mimic the native antigen. Although conformational restriction on synthetic peptides can be imposed by chemical methods (Satterthwait, A. et al., WHO Bulletin OMS 68, 17-25 (1990)) there is no guarantee that these new conformations will approximate the geometry of the same epitope in the native antigen to enable immunological cross-reactivity.

Protein engineering techniques have made it possible to express oligopeptide epitopes of biological interest in a variety of systems. These include among others bacterial flagellar filaments (Kuwajiima, G. et al., Bio/Technology 6, 1080-1083 (1988)), fimbrial subunits (Jennings, P. A. et al., Protein Eng. 2, 365-369 (1989)), and hepatitis B surface antigen (Rutgers, T. et al., Bio/Technology 6, 1065-1070 (1988)). With the exception of the hepatitis B surface antigen Schodel, F. et al., J Exp Med 180, 1037-46 (1994)), the other approaches are of limited utility for human use.

An easy way to express discrete peptide sequences of biological interest with constrained conformation is expression in the CDRs of an antibody (Zanetti, Nature 355, 466-477 (1992)). The process as originally described consists in grafting the coding region of epitopes of interest into one or several CDRs of an antibody variable (V) region (Zanetti, Nature 355, 466-477 (1992)). The process was termed “antibody antigenization” and its product “antigenized antibodies” because epitopes grafted into the CDRs constitute bits of antigen in an antibody.

An antibody globular domain is an excellent scaffold to immobilize and express heterologous epitopes due to the physico-chemical properties of the antibody molecule. The structure of the V domains of immunoglobulin (Ig) is well characterized (Alzari, P. M. et al., Ann. Rev. Immunol. 6, 555-580 (1988)). These are composed of framework regions (FR) organized as b-strands interconnected by, and supporting, CDR loops; three for the V region of the heavy (H) and three for the V region of the light (L) chain. The FR are arranged in a b-sheet sandwich (Ig-fold) filled with tightly packed hydrophobic side chains and invariant disulfide bonds that link two sheets together. While FR are relatively conserved among different antibodies, CDR loops at the top of the V-domains vary in sequence and length (Kabat, E. A. et al., ed. Health, N.I. U.S. Department of Health and Human Services, Bethesda (1987)). This variability accounts for most of the antigen-binding properties of antibodies. Most antigenic determinants of antibody V regions map to CDR loops although residues in the FR may also participate.

Loops of V domains are by definition solvent accessible, exposed areas at the surface of the molecule where both convexity and relative rigidity are important factors (Novotny, J. & Franek, F., Nature 258, 641-643 (1975)). Thus, the conformation of the six CDR loops is the principal determinant of the architecture of the antigen-binding site, and, at the same time, the major contributor to antibody antigenicity. Recent studies indicate that, for at least five out of six CDR loops, there exists a discrete repertoire of main chain conformations (canonical structures) upon which alternative combination and side chain diversity generate a wide range of binding sites and, consequently, antigenic structures (Chothia, C. et al., Nature 342, 877-83 (1989); Chothia, C. et al., J. Mol. Bio. 186, 651-663 (1985))

Structurally, the main advantage of antigenization of antibodies is that this is a formidably simple method to constrain discrete peptidic structures with biological activity (antigenicity and ligand function) and immunogenic function (ability to induce a specific and biologically active antibody response (Zanetti, M. & Billetta, R. (eds) Hardwood Academic Publishes, Amsterdam (1996)).

An example of an antigenized antibody is disclosed in Zanetti et. al., EMBO 12, 4375-4384 (1993) where an antibody was engineered to contain three RGD repeats ion the third CDR. This antibody mimics the ligand function of natural exrtracellular matrix proteins such as the integren avb,3 (insert Greek symbols). Lanza et. al. Blood Cells, Molecules and Diseases 23, 230-241 (1997).

An antibody was engineered to contain NAPN in the third CDR. This peptide was derived from the cicumsporozite protein of Plasmodium falciparum. Billetta et. al, Proc. Natl. Acad. Sci. USA, 88, 4713-4717 (1991). Immunization with this antigenized antibody induced antibodies that blocked in vitro P. falciparum of human hepatocytes. See also U.S. Pat. No. 5,658,762.

### SUMMARY OF THE INVENTION

Antigenized antibodies are antibody molecules with defined antigenic and immunogenic chemical characteristics imparted by grafting heterologous coding sequences in the complementarity determining regions (CDRs). Antigenized antibodies can be used as (1) immunogens to induce antibody responses specific for the heterologous sequences expressed in the CDRs, and (b) soluble ligands with a molecular weight enabling retardation in the clearance from the body (e.g., through the basement membrane of the kidney which retains anything bigger than 70 Kd). The invention discloses a method to generate antigenized antibodies through a high through put expression and screening process. This is a multi step process where, in relatively short time, cDNA libraries of single chain antibodies (ScFV) are used to express conformationally constrained peptidic motifs as the result of randomization of one or several CDRs. ScFV libraries are expressed in a cell-free ribosome expression system and antigenized CDRs are screened by bio-panning using antibodies against a molecular target choice. Preferably antibodies used in the bio-panning are selected among those already validated clinically. These may include Avastin (anti-VEGF), Herceptin (anti-Her-2Neu), Rituximab (anti-CD20) in the field of cancer and Infliximab (anti-TNF-alpha) in the field of inflammatory/autoimmune diseases. Thus, while expression of heterologous peptides in the scaffold of a ScFV has defined geometry, the invention enables one skilled in the art to use a high through put approach to identify antigenized CDRs expressing conformationally-constrained peptide motifs that bind the antibody used for bio-panning. In fact, the geometry of the V region fold is such that the expressed peptide identified through the high throughput screening is in a conformation that is only allows limited flexibility and this does not change once the antigenized ScFv fragment containing the peptide sequence identified by high throughput screening is developed into a pharmaceutical product, e.g., (vaccine or ligand).

Besides antibodies other binding molecules can be used. In an alternate embodiment, receptors are used to pan for antigenized antibodies that present an epitope(s) that cross reacts with an epitope of a ligand for the receptor. Such antigenized antibodies can be used to induce an immune response to the receptors' ligand.

### BRIEF DESCRIPTION OF THE DRAWINGS

FIG. 1 is a schematic representation of the process of genetic randomization of the CDR3 of a VH region.

FIG. 2 is a schematic representation of the ARM complex and its relation with the ribosome. The ARM complex is composed of two distinct components, the ScFv (a folded protein), and the mRNA, both connected to the ribosome. The CH3 spacer enables folding of the ScFV out of the ribosome pocket.

FIG. 3 is a schematic of the immunogenomic process to generate antigenized ScFV loops expressing a conformational constrained motif recognized by the binding site of monoclonal antibody against TNFa or a TNFa receptor.

FIG. 4 is a diagram of the clone that can be used for randomization and ribosome display. This is composed of three segments each defined by a different color: V_{H}, LK-V_{L} and C_{H}3. The V_{H} carries the randomised CDR3 loop. The LK-V_{L} segment participates in the stabilization of the Fv globular site hence providing a fixed geometry to the randomised CDR3 loop. The C_{H}3 enables the correct expression and folding of the single-chain antibody. (Not to scale)

FIG. 5 is a diagram of the generation of the mutagenesis clone by PCR. Fragment I and II are isolated by PCR with overlapping primers localized at the 3′ of Fragment I and at the 5′ of Fragment II. These regions anneal at a specific temperature. The extended fragment is amplified by adding the flanking primers to the PCR reaction.

FIG. 6 is a schematic view showing the randomization of the CDR3 loop.

FIG. 7 is a schematic of the preparation of randomized library.

### DETAILED DESCRIPTION OF THE INVENTION

The invention relates to methods for generating antigenized antibodies using a high throughput approach to render their identification and production simpler and faster. This process is termed Immunogenomics.

The first step in the process is the generation of libraries of single chain antibody (ScFv) in which in one or several CDRs contain polynucleotide sequences that are randomized by genetic engineering methods. For instance, several investigators have shown that the CDR3 loop can be randomized either in its complete sequence or at the level of fixed amino acid residues to impart a new or improved binding property (Barbas, C. D. et al., Proc Natl Acad Sci USA 89, 4457-61 (1992); Korpimaki, T. et al., Protein Eng 16, 37-46 (2003)).

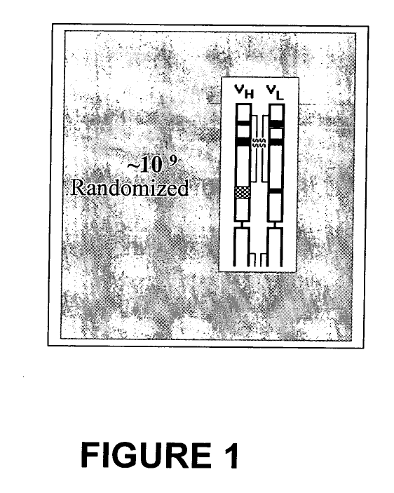

FIG. 1 illustrates the step of randomization of the CDR3 of a single chain antibody (ScFv) schematically composed of a VH and a VL region linked together through a suitable amino acid sequence. By a way of example the randomization of the CDR3 with nucleotide segments coding for 7-11 amino acid long epitopes is expected to yield CDR3 loops with 10⁹ possible amino acid combinations.

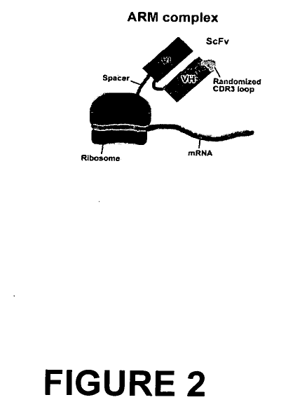

The second step is to express the ScFV library using a cell free ribosome display system. The ribosome display is a cell-free selection system based on the formation of a stabile antibody-ribosome-mRNA (ARM) complexes, (Hanes, J. & Pluckthun, A., Proc Natl Acad Sci USA 94, 4937-42 (1997); He, M. & Taussig, M. J., Nucleic Acids Res 25, 5132-4 (1997)). The in vitro transcription/translation reaction at the level of free ribosomes and the relative position of ARM complexes is illustrated in FIG. 2.

The third step is to screen the library to identify ScFv expressing loops of interest. Since the complexes are stable at 4° C., randomized ScFv libraries expressed in ribosomes can be screened by bio-panning with antibodies of known specificity immobilized on a solid support, e.g., a polyvinyl microtiter plate. This procedure is rapid, inexpensive, and can be replicated several times with minimal use of reagents.

Once specific ScFv binders are retained by bio-panning (this may take 3-4 rounds of panning), ARM complexes expressing high affinity interaction with the reference antibody can be further selected by another round of bio-panning performed in the presence of a soluble competitor, e.g., the specific ligand for the antibody. This will maximize the probability of selecting antigenized loops displaying a high affinity interaction with the reference antibody.

Although the figures provide for the randomization of one CDR only, it is possible to randomize simultaneously two or three CDRs to enable a complex three-dimensional structure resulting from the spacial proximity of the side chains of residues located in the different CDRs. The process is therefore not limited to linear epitopes.

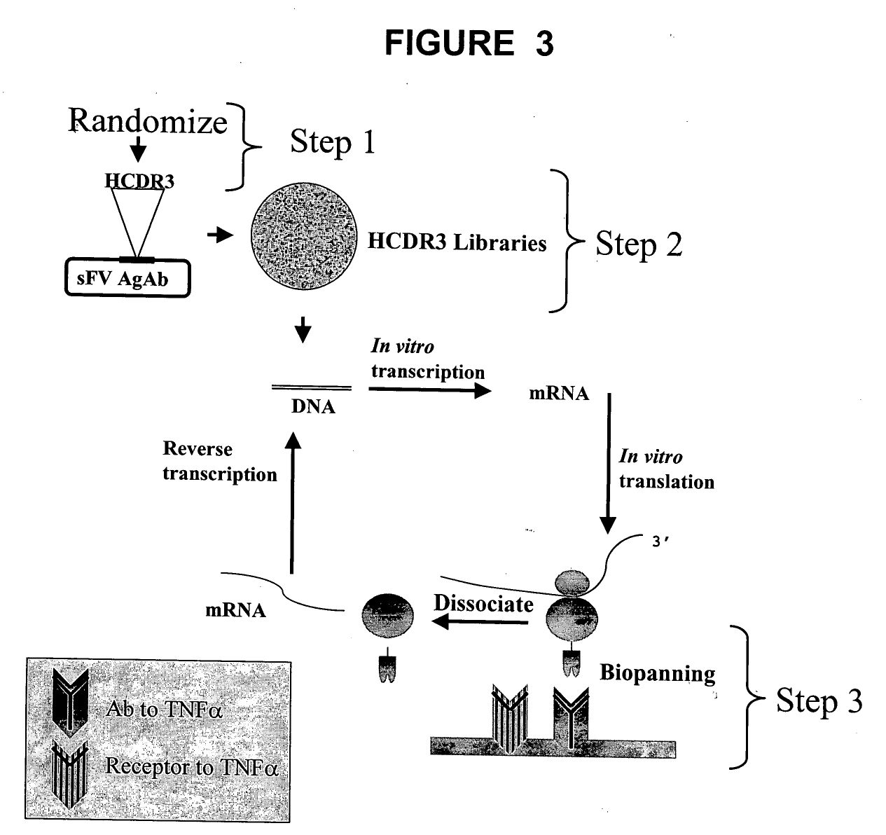

By way of example, the invention provides immunogenomics that can be used to generate ScFv mimics epitopes of ligands such as of TNF-alpha (FIG. 3). The role of this cytokine in inflammation is well known. Its causative role in chronic inflammatory/degenerative diseases such as rheumatoid arthritis and Crohn's disease is also known and passive therapy by means of antibody or soluble TNF receptor are currently in use. Such antibodies include Humira (Icos, Seattle, Wash.), Remicade (Centocor-Johnson & Johnson, Raritan, N.J.) and Enbrel (Immunex-Amgen, Thousand Oaks, Calif.).

A link between chronic production of TNF-alpha and tumorigenesis has been proposed (Pikarsky, E. et al., Nature 431, 461-6 (2004); Maeda, S. et al., Cell 121, 977-90 (2005)) suggesting that treatments that control the levels of TNF-alpha in the extracellular compartment may be useful in the control of cancer as well.

With a suitable antigenized antibody, one can replace passive treatments by monoclonal antibodies against TNF-alpha or a soluble TNF-alpha receptor with active immunization with an antigenized antibody.

Such an antigenized antibody can be selected from a ScFV library by using the disclosed cell free ribosome expression system of the invention the TNF-alpha receptor to pan for antigenized antibodies that bind to the TNF-alpha receptor (e.g. immobilized soluble TNF2R-Fc in FIG. 3) or an antibody such as Himira, Remicade or Embril (anti-TNF-aplha in FIG. 3).

The mRNA encoding the selected TNF-alpha antigenized antibody is reverse transcribed and expressed in a recombinant expression system to produce anti-TNF-alpha antigenized antibody. That antigenized antibody can then be administered as a vaccine to an individual suffering from rheumatoid arthritis or other diseases associated with TNF-alpha.

### EXAMPLES

Typically, the selection of peptidic motifs conformationally constrained within an antigenized antibody loop will be guided and made possible using either a preexisiting antibody or a receptor attached to a solid support, e.g., polyvinyl microtiter plates. Antibodies and receptors can serve as a “mold” to capture conformational motifs expressed by antigenized ScFv libraries, that is libraries created by random mutagenesis of at least one compelmentarity-determining region or CDR.

For sake of simplicity, the example provided herein describes the randomization of the third CDR (CDR3). The CDR3 loop is the most variable among the six CDRs with respect to length and amino acid composition making it is an ideal site to express random amino acid sequences.

The CDR3 loop has in the past been engineered to express heterologous epitopes of various size (from a minimum of 3 to a maximum of 22 amino acids) and varying amino acid composition without apparent negative consequences on folding. See Table 1.

TABLE 1

List of Amino Acid Sequences Engineered in
Antigenized Antibodies

Actual Engineered

| | | | | |
|---|---|---|---|---|
| # | Location | Motif | Sequence | Comments |

| | | | | |
|---|---|---|---|---|
| 1 | (3AAs) | RGD | VP-RGD-VP | Adhesion motiff/Integrin |
| | | | | ligand |
| 2 | (9AAs) | RGD₃ | VP-RGDRGDRGD-VP | Repeated adhesion |
| | | | | motiff/Integrin ligand |
| 3 | (12AAs) | NANP₃ | VP-NANPNANPNANP-VP | Dominant B-cell epitope |
| | | | | of malaria |
| | | | | Circumsporozoite (CS) |
| | | | | envelope protein |
| 4 | (12AAs) | NGNP₃ | VP-NGNPNGNPNGNP-VP | Dominant B-cell epitope |
| | | | | of malaria |
| | | | | Circumsporozoite (CS) |
| | | | | envelope protein |
| 5 | (12AAs) | NANG₃ | VP-NANGNANGNANG-VP | Point mutation of the |
| | | | | NANP₃ motiff |
| 6 | (9AAs) | NNP₃ | VP-NNPNNPNNP-VP | Mutation of the NANP₃ |
| | | | | motiff |
| 7 | (9AAs) | PNA₃ | VP-PNAPNAPNA-VP | Mutation of the NANP₃ |
| | | | | motiff |
| 8 | (10AAs) | nc-scr | VP-NTRKVDVREG-VP | Amino acids of the neuron |
| | | | | specific c-src, pp^{60c-src(+)} |
| 9 | (14AAs) | NP-CTL | VP-ASNENMETMESSTL-VP | Residues 366-379 of the |
| | | | | Influenza virus |
| | | | | Nucleoprotein (NP) |
| 10 | (7AAs) | CS-TH | VP-DKHIEQY-NP | T-helper epitope of the |
| | | | | CS protein |
| 11 | (8AAs) | CD4₄₂₋₄₉ | VP-SFLTKGPS-VP | Residues 42-49 of the D1 |
| | | | | domain of the human CD4 |
| | | | | receptor |
| 12 | (15AAs) | CD4₄₁₋₅₅ | VP-GSFLTKGPSKLNDRA-VP | Residues 41-55 of the D1 |
| | | | | domain of the human CD4 |
| | | | | receptor |
| 13 | (12AAs) | CD4₃₈₋₄₉ | VP-GNQGSFLTKGPS-VP | Residues 38-49 of the D1 |
| | | | | domain of the human CD4 |
| | | | | receptor |
| 14 | (12AAs) | CD4_{38-49Q40>A} | VP-GNAGSFLTKGPS-VP | Residues 38-49 of the D1 |
| | | | | domain of the human CD4 |
| | | | | receptor, containing a point |
| | | | | mutation at the AA 40, Q > A |
| 15 | (9AAs) | TCR-I | VP-ASSDSSNTE-VP | Residues of the CDR3 (VDJ |
| | | | | region) of the Vβ8.2 gene |
| | | | | product of rat TCR receptor |
| 16 | (21AAs) | TCR-II | VP- | Residues of the CDR2 of the |
| | | | DMGHGLRLIHYSYDVNSTEKG- | Vβ8.2 gene product of rat |
| | | | VP | TCR receptor |
| 17 | (13AAs) | MHC II | VP-FEAQGALANIAVD-VP | Residues 58-71 of the I-Eα |
| | | | | chain of MHC class II |
| | | | | molecule |
| 18 | (11AAs) | HBV-A | VP-ILGWSPQAQGI-VP | Residues 74-84 of the |
| | | | | Hepatatis B envelope |
| | | | | antigen (HBenvAg) |
| 19 | (11AAs) | HBV-B | VP-MQWNSTAFHQT-VP | Residues 120-130 of the |
| | | | | Hepatatis B envelope |
| | | | | antigen (HbenvAg) |
| 20 | (10AAs) | mCAT-2 | VP-AQINSKTKTP-VP | Amino acid transporter |
| 21 | (9AAs) | mCAT-2a | VP-ARVSKRQSP-VP | Amino acid transporter |

Thus, the expression of discrete peptidic ligands is conveniently realized in the CDR3 of the V region of an antibody molecule which is a solvent accessible loop. Several groups have also shown that the CDR3 loop can be randomized either in its complete sequence or at the level of fixed amino acid residues to impart a new binding property or to increase the affinity of an antibody molecule altogether. He, M. & M. J. Taussig, Nucleic Acids Research (Online), 25:5132-5134 (1997); Hanes, J. & A. Pluckthun, Proc Natl Acad Sci USA, 94:4937-4942.(1997); Barbas, C. F. et al., Proc Natl Acad Sci USA, 89:4457-4461 (1992).

Error-prone PCR, DNA shuffling, or RNA-dependent RNA polymerases mutagenesis have all been used to cause affinity maturation and protein evolution or to increase the recognition of ligands.

The “Randomization of a ScFv Clone

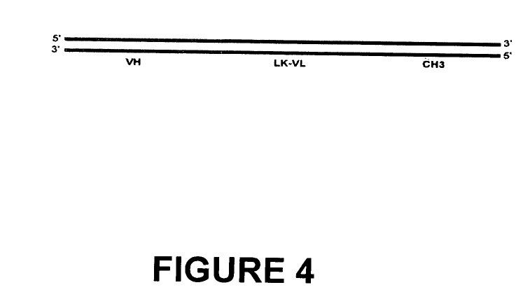

A prototype ScFv clone for randomization as described below (and subsequently used in ribosome display) is composed of three segments: (1) The V_{H} segment (e.g., the productively rearranged murine V_{H}, a member of the V_{H}7183 gene family); (2) The linker-V_{L} segment (the V_{H} fragment is connected to the V_{L} region through a linker (LK) made, for example, of a Glycine and Serine motif (3GlySer)4 that allows for correct folding and pairing of the ScFv (the V_{L} region can be a murine V_{K} chain that originally was part of an antibody that binds a fungal mannose-protein); and (3) The C_{H}3 segment. (which can be derived from a human IgG constant region and is used as a spacer to allow the ScFv to escape from the ribosome pocket and fold/express properly). The basic elements are diagrammatically presented in (FIG. 4).

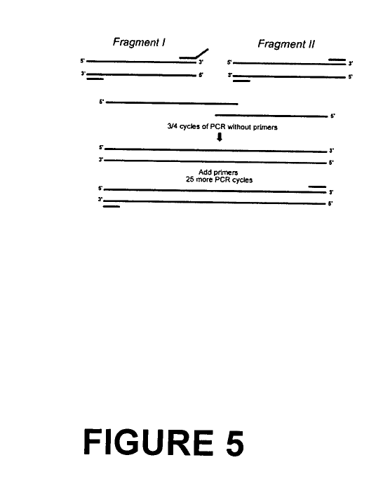

The mutagenesis clone is obtained by overlap-extension PCR with Pfu High-Fidelity polymerase (Stratagene). This technique has been used in the past for PCR cloning as well as to construct synthetic genes. Overlap-extension PCR is performed using primers containing overlapping regions so as to anneal two fragments. The extended fragment is then been amplified by the addition of flanking primers. See FIG. 5.

Randomization of the CDR3

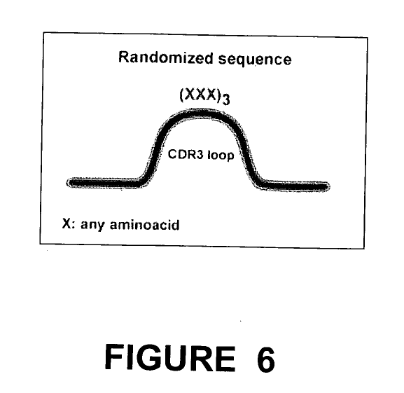

The CDR3 loop of the original V_{H}62 gene is randomized as follows. The XXX amino acids of the CDR3 are randomized by the megaprimer technique. Barbas, C. F., et al. Proc Natl Acad Sci U S A, 89:4457-4461 (1992). See FIG. 6.

The randomization primer has a central randomized sequence (SNN)X for a total of XXXbp and two flanking sequences of 34 bp that anneal within the V_{H} region. Two randomized primers are synthesized and purified by PAGE. Thus two sets of primers are used in this process: (i) CDR3 randomization primers: 5′-XXXbp-(SNN)X/XXXbp-3′ (ii) Primers for the randomization of flanking sequences: 5′-20/25 bp-(SNN)₃-(CGAGGAGAT)₃-(SNN)₃-20/25 bp-3′. The use of the randomized codon SNN reduces the probability to generate a stop codon.

Library Synthesis

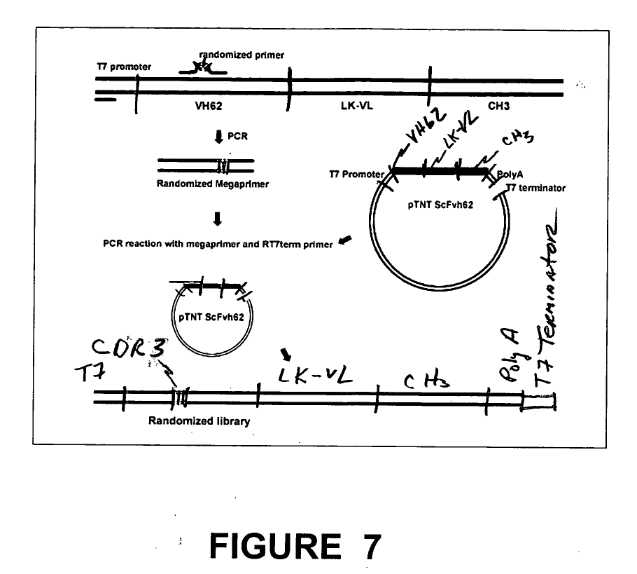

This double-strand primer is synthesized with Pfu High-Fidelity polymerase (Stratagene), and is used as a long-primer for the second PCR reaction where a third primer (3′ of the clone) allows the generation a full size library. The library contains a T7 terminator and a synthetic poly(A) known to improve both the quality and the yield of transcription and translation. See FIG. 7.

Ribosome Display and ScFv Selection

The invention is based on coupling random mutagenesis of one or more CDRs (e.g., CDR3) with a cell-free ribosome display system as a fast method to express and screen ScFv libraries. The ribosome display system is based on the formation of stable ScFv-ribosome-mRNA complexes called ARM complexes. ARM complexes are stable at +4° C. and can be selected on the paratope of antibodies by biopanning. This approach has been successfully used to screen human and murine ScFv antibodies.

The ribosome display system allows for the rapid expression of ScFv-ribosome-mRNA (ARM) complexes. Once the library has been purified by gel electrophoresis, a cell-free transcription and translation reaction (Promega pTNT in vitro coupled system) is used to generate ARM complexes (FIG. 2). These complexes are stable because they lack a stop codon. The C_{H}3 spacer, enables folding of ScFv protruding from the ribosome pocket.

The mRNA is recovered by an in-well RT reaction performed with the Sensible Superscript (Quiagen) and the solution is then used for further amplification by a two-step RT-PCR reaction. The DNA recovered from the PCR amplification is then used to perform a second ribosome display/panning using the same conditions. Five successive rounds of panning are generally sufficient to sort out specific from non-specific clones.

The in vitro transcription/translation reaction containing the ribosome complexes (ARM complexes) is assessed by ELISA on a 96-well plate coated with either a monoclonal antibody or a receptor. The complexes are panned for 1 hour at 4° C. and then washed three times with a cold (4° C.) buffer solution (PBS, 5 mM MgAc, 0.1% Tween 20) and once with H₂O+5 mM MgAc.

Library Screening

Once the library has been enriched for specific binders the ARM complexes are incubated with a soluble form of the reference antigen or ligand to create conditions of competitive inhibition hence maximizing the probability of selecting strong binders during the initial rounds of panning. This step is critical in that the possibility to select specific binders (ligands) with increased affinity for the paratope of the “mold” antibody or receptor. Non-specific binders in the library are identified by panning on antibodies or receptors of irrelevant specificity as a control.

Clone Sequencing

The DNA recovered after final panning is cloned in a pTNT vector to transform DH5a cells. Retained ScFv clones are sequenced and the resulting CDR3 loops analyzed.

What is claimed is:

1. A process comprising:
(a) contacting a single-chain variable region (ScVr) mRNA library with a cell free ribosome expression system to produce a library of complexes each comprising a ribosome, an ScVr mRNA and a nascent single chain antigenized antibody encoded by said ScVr mRNA (ARM complexes) wherein said ScFv mRNA library is randomized in at least one CDR region;
(b) contacting said ARM complexes with an antigen-specific antibody under conditions that permit binding of said antigen-specific antibody with a randomized CDR loop of the antigenized antibody of one or more of said ARM complexes; and
(c) separating ARM complexes bound to said antibody from ARM complexes that do not bind antigen specific antibody.

2. The process of claim 1 further comprising cloning the cDNA of the ScVr mRNA of at least one of said separated ARM complexes and expressing said cDNA to produce an antigenized antibody that binds to said antibody.

3. The process of claim 1 wherein said antibody specifically binds to a ligand.

4. The process of claim 3 wherein said ligand is selected from the group consisting of TNF-alpha, integrins, viral receptors, immune receptors, receptors involved in regulation of endocine pathways and their dysregulation in disease.

5. A process comprising:
(a) contacting a single-chain variable region (ScFv) mRNa library with a cell free ribosome expression system to produce a library of complexes each comprising a ribosome, an ScVr mRNA and a nascent single chain antigenized antibody encoded by said ScVr mRNA (ARM complexes) wherein said ScFv mRNA library is randomized in at least one CDR region;
(b) contacting said ARM complexes with a receptor under conditions that permit binding of said receptor with a randomized CDR loop of the antigenized antibody of one or more of said ARM complexes; and
(c) separating ARM complexes bound to said receptor from ARM complexes that do not bind said receptor.

6. The process of claim 5 further comprising cloning the cDNA of the ScVr mRNA of at least one of said separated ARM complexes and expressing said cDNA to produce an antigenized antibody that binds to said receptor.

7. The process of claim 2 or 6 further comprising isolating said antigenized antibody.

8. A method for inducing an immune response comprising administering the antigenized antibody of claim 7 to a vertebrate.

9. A method for interfering with receptor function comprising administering the antigenized antibody of claim 8 to a vertebrate.
